(19) United States
(12) Patent Application Publication
(10) Pub. No.: US 2024/0384138 A1
(43) Pub. Date: Nov. 21, 2024

(54) CURABLE ORGANOPOLYSILOXANE COMPOSITION, SLIGHTLY-ADHESIVE ORGANOPOLYSILOXANE ADHESIVE AGENT LAYER OBTAINED BY CURING SAME, AND LAMINATE

(71) Applicant: DOW TORAY CO., LTD., Shinagawa-Ku, Tokyo (JP)

(72) Inventors: Yuki YOKOUCHI, Ichihara-shi, Chiba (JP); Tomohiro IIMURA, Ichihara-shi, Chiba (JP)

(21) Appl. No.: 18/691,861

(22) PCT Filed: Sep. 8, 2022
(86) PCT No.: PCT/JP2022/033709

§ 371 Date: Mar. 13, 2024

(30) Foreign Application Priority Data
Sep. 14, 2021 (JP) 2021-149268

(51) Int. Cl. C09J 7/38; B32B 7/12; B32B 27/08; B32B 27/36; B32B 37/12

(52) U.S. Cl. CPC C09J 7/385; B32B 7/12; B32B 27/08; B32B 27/36; B32B 37/1284; B32B 2037/1253; B32B 2250/02; B32B 2250/244; B32B 2255/10; B32B 2255/26; B32B 2307/414; B32B 2307/748; B32B 2310/0831; C09J 2301/302; C09J 2301/416

(57) ABSTRACT

Provided is a curable organopolysiloxane composition that can be heat curable and photocurable, has excellent transparency, and forms a slightly adhesive layer, enabling design of a composition that is coatable even when using a small amount of solvent, a cured product thereof, and use thereof. The curable organopolysiloxane composition comprises (A) a chain organopolysiloxane having an alkenyl group, (B) at least one type of radical reactive component selected from (B1) vinyl monomers, and (B2) (meth)acrylic group-containing organopolysiloxane compounds, and (C) a radical polymerization initiator. The sum of component (A) and component (B2) with respect to the total solid mass of the composition is 50 mass % or higher.

### TECHNICAL FIELD

The present invention relates to a curable organopolysiloxane composition that can be solvent free or low solvent as necessary, and forms a slightly adhesive organopolysiloxane adhesive layer with excellent transparency by advancing a radical polymerization curing reaction using heat or a high energy beam; a laminate body having the organopolysiloxane adhesive layer; and a manufacturing method thereof. Note that the adhesives in the present invention include so-called pressure-sensitive adhesives (=PSA).

### BACKGROUND ART

Curable silicone compositions that can form adhesive layers upon curing are used in a wide range of industrial fields because, when compared with acrylic and rubber-based adhesives and other adhesive compositions, they form adhesive layers that have enhanced heat resistance, cold resistance, electrical insulation, weather resistance, water repellency, and transparency. Cured silicone adhesive layers are particularly suitable for use as adhesives, sealants, or temporary attaching agents between members in processes for manufacturing optical materials and semiconductor devices, and the like, including high-temperature holding processes because, when compared with other organic materials, they have enhanced heat resistance, do not discolor easily even at high temperatures, and experience minimal deterioration in physical properties.

Taking advantage of the above characteristics of silicone adhesive layers as well as characteristics which can achieve high transparency thereof as required, applications in the field of advanced electronic materials and display elements, such as smart devices, have been investigated particularly in recent years. Such a device has a structure in which a film made of a plurality of layers, including an electrode layer and a display layer, is interposed between transparent substrates, and it is anticipated that the silicon adhesive layers having excellent heat resistance and cold resistance will function effectively in an article and a manufacturing process thereof for the purpose of protecting the electrode layer and the display layer and improving adhesion between layers.

These cured silicone adhesive products are classified based on the curing mechanisms thereof, such as addition reaction curing types, condensation reaction curing types, peroxide curing types, and the like. Addition reaction curing type silicone adhesive compositions are widely used because they harden quickly when left at room temperature or when heated, are not susceptible to turbidity in adhesive layers, have superior transparency, and do not generate by-products, but are, from the viewpoint of coatability and handling workability, generally commercialized by being dissolved in organic solvents, which limits their use. Particularly in recent years, the development of compositions that can be made solvent-free or low in solvent is strongly desired due to trends in environmental regulations around the world. In addition, there has been a growing trend toward lower energy consumption in manufacturing processes in recent years. Increasingly, these processes require photocurable materials that are cured by irradiation with a high energy beam such as ultraviolet rays, or the like, that do not require high temperatures. Additionally, processes for manufacturing semiconductors, and the like, have come to require easily releasable, slightly layers for temporarily attaching components or as protective films in recent years.

Patent Document 1 (particularly Preparation 1 and the like) discloses a solvent-free silicone adhesive composition and dicing tape that uses this composition, and the like, that include dimethylpolysiloxane having an acrylic group, an MQ type dimethylpolysiloxane resin, and a photopolymerization initiator. Similarly, Patent Document 2 discloses a solvent-free addition type silicone adhesive composition that contains an MQT^{OH} type resin component and a platinum catalyst. However, there is a problem with these silicone adhesive compositions in that they are difficult to cure within a practical curing time unless the temperature is substantially higher than 100° C., and because the adhesive layers contain large amounts of resin components, it is difficult to use them in applications that require slight adhesion and easy releasability.

Patent Document 3 discloses a solvent-free ultraviolet ray curable silicone adhesive composition that includes organopolysiloxane having a (meth)acrylic functional group, a monofunctional or polyfunctional acrylate monomer, an MQ type organopolysiloxane resin, and a photopolymerization initiator; and an application for temporary attaching, and the like. However, because this document does not disclose a composition based on an alkenyl group, and only a relatively hard adhesive layer containing a large amount of resin can be obtained with the composition disclosed in Patent Document 3, there is a strong demand for a silicone adhesive with slight adhesion derived from rubber-like viscoelastic properties of a cured product.

Note that, in Patent Document 4 (unpublished at the time of filing), the present applicants proposed a solvent-free/low-solvent silicone adhesive composition using a photoactivated hydrosilylation reaction catalyst that includes an organopolysiloxane resin with a relatively small molecular weight. However, the patent includes no description or suggestion regarding radically polymerizable compositions, and heating may be required if a practical curing time is to be achieved.

### RELATED ART DOCUMENTS

### Patent Documents

Patent Document 1: JP 2004-327801 A (JP 4171898 B2)
Patent Document 2: JP 2012-041505 A (JP 5234064 B2)
Patent Document 3: WO 2018/225430 A1
Patent Document 4: JP 2020-216896 A (unpublished at the time of filing)

### SUMMARY OF THE INVENTION

### Problem to be Solved by the Invention

The present invention was created to solve the above problem, and an object thereof is to provide a curable organopolysiloxane composition that provides a slightly adhesive cured product, and an organopolysiloxane adhesive layer that is a cured product thereof, that; enables the design of a composition with a viscosity that allows coating even with a low solvent content; that, depending on the industrial process, is usable not only for general-purpose heat curing processes but also for curing processes using a high energy beam such as ultraviolet rays and the like; and that also has superior transparency. Another object of the present invention is to provide a method for manufacturing a laminate body, the method including a step of adhering a laminate body that includes the organopolysiloxane adhesive layer to a substrate.

### Means for Solving the Problem

As a result of intensive study, the present inventors completed the present invention after discovering that the problem described above can be resolved by a curable organopolysiloxane composition that contains (A) 50 to 99 parts by mass of a chain organopolysiloxane having at least two alkenyl groups in each molecule, (B) 0.1 to 49.9 parts by mass of at least one type of radical reactive component selected from (B1) a monofunctional or polyfunctional vinyl monomer, and (B2) an organopolysiloxane compound having an organic group containing at least one acryl group or methacryl group in each molecule, wherein the sum of component (A) and component (B2) is at least 50 mass %, based on the total solid mass of the composition. The present composition can be designed to have sufficient coating properties even when solvent-free or low in solvents; enables, depending on choice of radical polymerization initiator, achievement of room temperature to low temperature curing characteristics through heat curing at high temperature or irradiation with a high energy beam; has superior transparency; and can form a slightly adhesive organopolysiloxane adhesive layer. Furthermore, the problem described above is resolved by a method for manufacturing a laminate body that includes the organopolysiloxane adhesive layer according to the present invention, the method including a step of applying, and then curing or semi-curing, the curable organopolysiloxane composition on a substrate.

### Effect of the Invention

The curable organopolysiloxane composition according to the present invention can be designed to have viscosity that allows coating even when the solvent content is low, and can be used not only for an industrially-used heat curing process, but also for a curing process that uses irradiation with a high energy beam such as ultraviolet rays by selecting a type of radical polymerization initiator that is a component (C); and can form an organopolysiloxane adhesive layer that has slight adhesiveness, superior transparency, and low turbidity (haziness) by curing or semi-curing. The present invention can also provide a method for manufacturing a laminate body, which method includes a step that adheres a laminate body that includes the organopolysiloxane adhesive layer to a substrate.

### DESCRIPTION OF THE PREFERRED EMBODIMENTS

A curable silicone composition according to the present invention contains the components (A) through (C) described above. Additionally, from the perspective of handling workability, the composition may optionally contain an organic solvent (D) as well as a photosensitizer and other additives to an extent that does not conflict with the object of the present invention. Each component is described below.

### [Component (A)]

Component (A) is a chain polysiloxane molecule with at least two alkenyl groups in each molecule, and is the main ingredient (base polymer) of this composition. Examples of the alkenyl groups of the organopolysiloxane of component (A) include alkenyl groups having 2 to 10 carbon atoms, such as vinyl groups, allyl groups, butenyl groups, pentenyl groups, hexenyl groups, and heptenyl groups, with vinyl groups or hexenyl groups being particularly preferable. Examples of the bonding position of the alkenyl groups of component (A) include the molecular chain ends and/or the molecular side chains. From the perspective of the technical effects of the present invention, at least a portion or all of component (A) preferably has an alkenyl group bonded to a silicon atom at a site other than an end of a molecular chain, and the use of a chain organopolysiloxane having an alkenyl group on a side chain of a molecular chain is one preferred embodiment of the present invention. Note that component (A) may contain a single component or may be a mixture of two or more different components.

Examples of organic groups bonded to silicon atoms other than alkenyl groups in the organopolysiloxane of component (A) include: alkyl groups such as methyl groups, ethyl groups, propyl groups, butyl groups, pentyl groups, hexyl groups, and heptyl groups; aryl groups such as phenyl groups, tolyl groups, xylyl groups, and naphthyl groups; aralkyl groups such as benzyl groups and phenethyl groups; and halogenated alkyl groups such as chloromethyl groups, 3-chloropropyl groups, and 3,3,3-trifluoropropyl groups, with methyl groups and phenyl groups being particularly preferable.

Component (A) is different from component (B) and has a chain polysiloxane molecular structure. For example, component (A) is preferably a straight-chain or partially branched straight-chain and may partially include a cyclic three-dimensional network. Preferably, the main chain contains repeating diorganosiloxane units and is preferably a straight-chain or branched diorganopolysiloxane blocked at both molecular chain ends with triorganosiloxy groups. Note that the siloxane units which provide a branched organopolysiloxane are T units or Q units described below.

At room temperature, component (A) may have oil-like or raw rubber-like properties, however, particularly if the curable organopolysiloxane composition according to the present invention is a solvent-free or low-solvent composition, component (A) preferably has oil-like properties at room temperature, from the perspective of coating properties. Component (A) preferably has a viscosity at 25° C. of 1 mPa·s or more and 100000 mPa·s or less, and in view of the vinyl content described later, a viscosity of 10 mPa·s or more, 50000 mPa·s or less, and 10000 mPa·s or less is particularly preferable. Note that when the curable organopolysiloxane composition of the present invention is a solvent type, at least a portion of component (A) may be a raw rubber-like alkenyl group-containing organopolysiloxane having a viscosity exceeding 100000 mPa·s at 25° C. or having a plasticity (thickness when a 1 kgf load applied for 3 minutes to a 4.2 g spherical sample at 25° C. is read up to 1/100 mm and this value is multiplied by 100) within the range of 50 to 200, and more preferably within the range of 80 to 180 as measured in accordance with the method as prescribed in JIS K6249.

The amount of alkenyl groups in component (A) is preferably in the range of 0.001 to 10.0 mass %, preferably in the range of 0.005 to 5.0 mass %, and more preferably in the range of 0.01 to 3.0 mass % with respect to the mass of component (A). In particular, it is preferable to use an organosiloxane in which the amount of the vinyl (CH₂═CH—) moiety in the aliphatic unsaturated carbon-carbon bond-containing group (hereinafter referred to as the “vinyl content”) is in the range of 0.005 to 10.0 mass %, and particularly preferably in the range of 0.005 to 5.0 mass %.

Component (A) may include, as an organic group other than an aliphatic unsaturated carbon-carbon bond-containing group, a methyl group, an ethyl group, a propyl group, a butyl group, a pentyl group, a hexyl group, a heptyl group, or other alkyl group; a phenyl group, a tolyl group, a xylyl group, a naphthyl group, or other aryl group; a benzyl group, a phenethyl group, or other aralkyl group; a phenethyl group or other aralkyl group; and a chloromethyl group, a 3-chloropropyl group, a 3,3,3-trifluoropropyl group, or other alkyl halide group. From an industrial perspective, it is particularly preferable to include a methyl group. On the other hand, from the perspective of elongation of the cured product particularly at high temperature, adherence to a base material, and transparency, and particularly reducing haze value, a methyl group is preferred as the organic group other than the aliphatic unsaturated carbon-carbon bond-containing group in component (A), and the amount of aryl groups or aralkyl groups is less than 0.1 mol % with respect to the total number of groups bonded to a silicon atom, and particularly 0.0 mol %. Thus, an aryl group or an aralkyl group is preferably essentially not included.

Such component (A) may be used alone or as a mixture of a plurality. However, from the perspective of the technical effects of the present invention, and particularly the elongation of a cured product and adherence to a base material, component (A) may be a mixture containing:
(A1) a linear or branched organopolysiloxane having at least two alkenyl groups only at both molecular chain ends; and
(A2) a linear or branched organopolysiloxane having at least one alkenyl group at a site other than a molecular chain end and having at least three alkenyl groups in a molecule, at a mass ratio of 30:70 to 70:30.
   Furthermore, these components (A1) and (A2) may and preferably are mixtures of two or more types of components with different viscosities, degrees of siloxane polymerization, or alkenyl group amounts.

Note that volatile or low molecular weight siloxane oligomers (octamethyltetrasiloxane (D4), decamethylpentasiloxane (D5)), and the like are preferably reduced or removed from component (A), from the perspective of preventing contact failure. While the amount can be designed as desired, the amount may be less than 1 mass % of all of component (A), less than 0.1 mass % of siloxane oligomers, or may be reduced to a level near the detection limit, as required.

### [Component (B)]

The composition of the present invention may include one or more radical reactive component selected from (B1) monofunctional or polyfunctional vinyl monomers and (B2) an organopolysiloxane compound having an organic group containing at least one of an acryl or methacryl group in a molecule. Note that the term “(meth)acrylic acid” as used below indicates that both acrylic acid and methacrylic acid are included. Similarly, “(meth)acrylate”, “(meth)acryloxy”, and “(meth)acrylamide” also indicate that both acrylate and methacrylate, acryloxy and methacryloxy, and acrylamide and methacrylamide, respectively, are included.

Similar to component (A), component (B) is a radical reactive component because a carbon-carbon unsaturated double bond derived mainly from an acryl or methacryl group is included in a molecule, and participates in a curing reaction through radical polymerization, similar to component (A). Therefore, when component (B) is used jointly, it is possible to adjust the adhesive strength to a substrate, cross-linking density of a cured product, and the like; and depending on the amount of the composition used, to adjust the adhesiveness of the organopolysiloxane adhesive layer obtained by curing or semi-curing the present composition to the substrate so as to achieve slight adhesiveness. Thus, component (D) is particularly useful in adjusting the cross-linking density, and adjusting the adhesiveness to the substrate.

The amount of component (B), which is a radical reactive component, used is within the range of 0.1 to 49.9 parts by mass, and particularly preferably, within the range of 0.1 to 25 parts by mass relative to 50 to 99 parts by mass of component (A). In particular, the sum of component (A) and component (B2) in the composition according to the present invention must be 50 mass % or more based on the total solid mass, and if the amount of component (B) exceeds the above upper limit, the organopolysiloxane adhesive layer formed by curing the composition will tend to be hard and brittle, in addition to being unable to be used sufficiently as a slightly adhesive layer, and turbidity (haziness) may occur, impairing the transparency of the adhesive layer. On the other hand, if the content of component (B) is less than the above-mentioned lower limit, curing speed, crosslinking density, and the like, of the organopolysiloxane adhesive layer will be insufficiently adjusted, and the object of creating a slightly adhesive layer may not be achieved.

Component (B1) is a vinyl monomer, which is a starting material for an organic resin generally referred to as a vinyl resin. Examples thereof include: methyl (meth)acrylate, ethyl (meth)acrylate, n-propyl (meth)acrylate, isopropyl (meth)acrylate, and other lower alkyl (meth)acrylates; glycidyl (meth)acrylates; n-butyl (meth)acrylate, isobutyl (meth)acrylate, tert-butyl (meth)acrylate, n-hexyl (meth)acrylate, cyclohexyl (meth)acrylate, 2-ethylhexyl (meth)acrylate, isoamyl (meth)acrylate, octyl (meth)acrylate, dodecyl (meth)acrylate, isobornyl (meth)acrylate, stearyl (meth)acrylate, dicyclopentanyl (meth)acrylate, dicyclopentenyl (meth)acrylate, 3,3,5-tricyclohexyl (meth)acrylate, phenoxyethyl (meth)acrylate, and other higher (meth)acrylates; vinyl acetate, vinyl propionate, and other lower fatty acid vinyl esters; vinyl butyrate, vinyl caproate, vinyl 2-ethylhexanoate, vinyl laurate, vinyl stearate, and other higher fatty acid esters; styrene, vinyl toluene, benzyl (meth)acrylate, phenoxyethyl (meth)acrylate, vinyl pyrrolidone, and other aromatic vinyl monomers; (meth)acrylamide, N-methylol (meth)acrylamide, N-methoxymethyl (meth)acrylamide, isobutoxymethoxy (meth)acrylamide, N,N-dimethyl (meth)acrylamide, and other amide group-containing vinyl monomers; 2-hydroxyethyl (meth)acrylate, 4-hydroxybutyl (meth)acrylate, 2-hydroxybutyl (meth)acrylate, 2-hydroxypropyl (meth)acrylate, tetrahydrofurfuryl (meth)acrylate, and other hydroxyl group-containing vinyl monomers; trifluoropropyl (meth)acrylate, perfluorobutylethyl (meth)acrylate, perfluorooctylethyl (meth)acrylate, and other fluorine-containing vinyl monomers; glycidyl (meth)acrylate, 3,4 epoxycyclohexylmethyl (meth)acrylate, and other epoxy group-containing vinyl monomers; (meth)acrylic acid, itaconic acid, crotonic acid, fumaric acid, maleic acid, and other carboxylic acid-containing vinyl monomers; tetrahydrofurfuryl (meth)acrylate, butoxyethyl (meth)acrylate, ethoxydiethylene glycol (meth)acrylate, polyethylene glycol (meth)acrylate, polypropylene glycol mono(meth)acrylate, hydroxybutyl vinyl ether, cetyl vinyl ether, 2-ethylhexyl vinyl ether, diethylene glycol monoethyl ether (meth)acrylate, diethylene glycol monomethyl ether (meth)acrylate, and other ether bond-containing vinyl monomers; (meth)acryloxy propyltrimethoxysilane, polydimethylsiloxane containing a styryl group at one end, and other unsaturated group-containing silicone compounds; butadiene; vinyl chloride; vinylidene chloride; (meth)acrylonitrile; dibutyl fumarate; maleic anhydride; dodecyl succinic anhydride; (meth)acryl glycidyl ether; alkali metal salt, ammonium salt, or organic amine salt of a radically polymerizable unsaturated carboxylic acid such as (meth)acrylic acid, itaconic acid, crotonic acid, fumaric acid, maleic acid, or the like; radically polymerizable unsaturated monomers having a sulfonic acid group such as styrene sulfonic acid, as well as alkali metal salts thereof, ammonium salts thereof, and organic amine salts thereof; and quaternary ammonium salts derived from (meth)acrylic acid, such as 2-hydroxy-3-methacryloxy propyltrimethylammonium chloride, methacrylate esters of alcohols having a tertiary amine group, such as a diethylamine methacrylate ester, and quaternary ammonium salts thereof.

Similarly, a polyfunctional vinyl monomer can also be used. Examples thereof include (meth)acryloyl group-containing monomers such as ethylene glycol di(meth)acrylate, diethylene glycol di(meth)acrylate, triethylene glycol di(meth)acrylate, neopentyl glycol di(meth)acrylate, polyethylene glycol di(meth)acrylate, 1,4-bis((meth)acryloyloxy)butane, 1,6-bis((meth)acryloyloxy)hexane, 1,9-bis((meth)acryloyloxy)nonane, 1,12-bis((meth)acryloyloxy)dodecane, tris(2-acryloyloxy)ethyl isoctanurate, pentaerythritol tetraacrylate, trimethylolpropane tri(meth)acrylate, pentaerythritol tri(meth)acrylate, trimethylolpropane trioxyethyl(meth)acrylate, tris(2-hydroxyethyl)isocyanurate di(meth)acrylate, tris(2-hydroxyethyl)isocyanurate tri(meth)acrylate, adduct diol di(meth)acrylate of bisphenol A ethylene oxide or propylene oxide, ethylene oxide of hydrogenated bisphenol A or propylene oxide adduct diol di(meth)acrylate, triethylene glycol divinyl ether, and the like; and silicone compounds containing unsaturated groups such as polydimethylsiloxane blocked with styryl groups on both ends, and the like.

In the present invention, a preferred component (B1) is an acrylate vinyl monomer having one acryloxy group that can, when taking viscosity, curability, hardness after curing, and glass transition temperature of the compound into account, be used alone or in combination with two or more types thereof. Of these, acrylate compounds or methacrylate compounds having 8 or more, preferably 8 to 30, carbon atoms in each molecule are preferred from the perspective of providing low volatility, low composition viscosity, and high cured product glass transition temperature; more specifically, a vinyl monomer selected from dodecyl acrylate, 2-ethylhexyl acrylate, isobornyl acrylate, and dicyclopentanyl acrylate is preferred.

Similarly, a preferred component (B1) is an acrylate vinyl monomer with two acryloxy groups that, taking into consideration compound viscosity and curability, compatibility with the above-mentioned compound with one acryloxy group, and hardness and glass transition temperature after curing, can be used alone or in combination with two or more thereof. Diethyleneglycol diacrylate, 1,6-bis(acryloyloxy)hexane, trimethylolpropane triacrylate, and polydimethylsiloxane having acryloxy functionality at both ends can be preferably used.

Furthermore, in consideration of the aforementioned properties, these compounds having two or more acryloxy groups can be used in combination with the compounds having one acryloxy group. In this case, both can be combined in any ratio, but usually the ratio of [compounds with two or more acryloxy groups]/[compounds with one acryloxy group] ranges from 1/99 to 50/50 (mass ratio). This is because if the ratio of compounds with two or more acryloxy groups is too high, the cured material will tend to be hard and brittle.

Component (B2) is an organopolysiloxane compound having an organic group containing at least one acryl or methacryl group in a molecule, and any resin-like, chain-like (including straight-chain and branched), cyclic, or resin-linear block copolymers including a resinous block and a chain block can be used.

Preferably, component (B2) is a chain organopolysiloxane having at least one silicon-bonded functional group R^{A} expressed by General Formula (1):

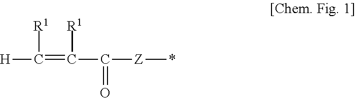

at the terminal or side chain of the molecular chain, where R¹ mutually independently represents a hydrogen atom, methyl group, or phenyl group, and is preferably a hydrogen atom or a methyl group in order to form an acryl or methacryl group moiety. Z represents a divalent organic group which may contain a hetero atom, and is bonded to a silicon atom included in the main chain of the polysiloxane represented by *, and may be a divalent organic group which may contain a silicon atom, oxygen atom, nitrogen atom, or sulfur atom.

Here Z represents an alkylene group having 2 to 22 carbon atoms, and is preferably one group selected from divalent organic groups expressed by —R³—C(═O)—O—R⁴— {where R³ is an alkylene group having 2 to 22 carbon atoms, R⁴ is a group selected from an ethylene group, a propylene group, a methylethylene group, or a hexylene group}, divalent organic groups expressed by —Z¹—X—C(═O)—X—Z² {where Z¹ represents —O(CH₂)ₖ— (where k is a number in the range of 0 to 3), and X represents an oxygen atom, nitrogen atom, or sulfur atom.

Z² represents a divalent organic group expressed by —[(CH₂)₂O]ₘ(CₙH₂ₙ)— (where m is a number in a range of 0 to 3 and n is a number in a range 2 to 10) bonded to a silicon atom included in the main chain of the polysiloxane represented by *}, and
divalent linking groups expressed by —Z¹—R2²Si—O—R²Si—Z²—, described below.

Particularly preferably, the silicon-bonded functional group (R^{A}) is expressed by general formula (2).

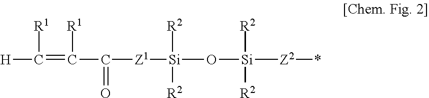

In the formula, R¹ mutually independently represents a hydrogen atom, a methyl group, or a phenyl group, and preferably a hydrogen atom or a methyl group. R² mutually independently represents an alkyl group or an aryl group, preferably an alkyl group or a phenyl group having 1 to 20 carbon atoms for industrial purposes, and particularly preferably a methyl group. Z¹ represents —O(CH₂)ₘ— (m is a number in the range 0 to 3), where m is preferably 1 or 2. Z² represents a divalent organic group expressed by —CₙH₂ₙ— (n is a number in a range of 2 to 10) bonded to a silicon atom configuring the main chain of the polysiloxane represented by *, and a case where n is 2 to 6 is preferred for practical use. It should be noted that the silicon atom-bonded functional group (R^{A}) expressed by general formula (1-1) can be introduced into a molecule by reacting a silicon atom-bonded functional group containing at least one alkenyl group (R^{Alk}) and a hydrosilane compound having a silicon atom-bonded hydrogen atom and (meth)acryl functional group in a molecule (e.g., 3-(1,1,3,3-tetramethyldisiloxanyl)propyl methacrylate and the like), in the presence of a hydrosilylation reaction catalyst. Furthermore, the same reaction may be and preferably is performed in the presence of a polymerization inhibitor such as dibutylhydroxytoluene (BHT).

More specifically, component (B2) may include one or more types of chain organopolysiloxanes selected from components (B2-1-1) and (B2-1-2) described below.

Component (B2-1-1) is a straight-chain organopolysiloxane having at least one functional group (R^{A}) in the molecule, as shown by the following structural formula.

Structural formula:

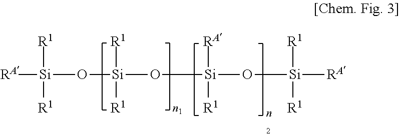

In the formula, R¹ mutually independently represents a C1 to C6 alkyl group, a C2 to C20 alkenyl group, or a C6 to C12 aryl group, R^{A′} mutually independently represents a group selected from C1 to C6 alkyl groups, C2 to C20 alkenyl groups, C6 to C12 aryl groups, and silicon atom-bonded functional groups (R^{A}) containing the aforementioned acryl or methacryl group, n1 is a positive number, and n2 is 0 or a positive number. However, when n2 is 0, at least one out of R^{A′} is a silicon atom-bonded functional group (R^{A}) containing the aforementioned acryl or methacryl group. n1+n2 is a positive number greater than or equal to 0 and is not limited, but is preferably in the range of 10 to 5000, more preferably 10 to 2000, and even more preferably 10 to 1000. Note that the value of n1+n2 may be and preferably is a number that satisfies a viscosity range such that the viscosity of component (C′1) at 25° C. is within the range of 1 to 100000 mPa·s, more preferably 10 to 50000 mPa·s, and even more preferably 500 to 50000 mPa·s.

Component (B2-1-2) is a branched organopolysiloxane that has at least one functional group (R^{A}) in a molecule and includes a branched siloxane unit, as shown by the average unit formula below.

Average unit formula:

(R^{A′}R¹₂SiO_{1/2})ₓ(R¹₂SiO_{2/2})_{y1}(R^{A′}R¹SiO_{2/2})_{y2}(R¹SiO_{3/2})_{z1}(R^{A′}SiO_{3/2})_{z2} (I-2)

In the formula, R¹ and R^{A′} represent the same groups as described above, and x, y1, y2, z1 and z2 represent the molar ratio when the sum of each siloxane unit is 1. Specifically, if all of the following conditions are satisfied: x+y1+y2+z1+z2=1, 0<x≤0.2, 0.3≤y1+y2<1, 0<z1+z2≤0.2, y2+z2=0, at least one R^{A′} is a silicon-bonded functional group (R^{A}) that includes the acrylic or methacrylic group described above. Note that either one or both y2 and z2 may be 0.

More specifically, the component (D2-1-2) is a branched organopolysiloxane expressed by the following siloxane unit formula.

(R^{A′}R¹₂SiO_{1/2})ₐ(R¹₂SiO_{2/2})_{b1}(R^{A′}R¹SiO_{2/2})_{b2}(R¹SiO_{3/2})_{c1}(R^{A′}SiO_{3/2})_{c2}

(where R¹ and R^{A′} are the same groups as above),
When expressed by the formula above, 0<a≤10, 15≤b1+b2<2000, and 0<c1+c2≤10, and in the case of b2+c2=0, at least one of R^{A′} is a silicon atom-bonded functional group (R^{A}) that includes the acryl or methacryl group described above.

As an example, component (B2-1-2) may be a branched organopolysiloxane having a methacryloyl group-containing organic group only on an end M unit expressed by the siloxane unit formula below.

(R^{A′}R¹₂SiO_{1/2})ₐ(R¹₂SiO_{2/2})_{b1}(R¹SiO_{3/2})_{c1}

In the formula, R¹ and R^{A′} represent the same groups as above, 0<a≤10, 15≤b1<2000, 0<c1≤10, and at least one of R^{A′} is a silicon atom-bonded functional group (R^{A}) that includes the acryl or methacryl group described above.

The viscosity of component (B2-1-2) at 25° C. is preferably 10 to 50000 mPa·s, and more preferably 100 to 2000 mPa·s.

Examples of component (B2) widely available on the market include branched or linear polydimethylsiloxanes that include a (meth)acryl group at one end, polydimethylsiloxanes blocked at both ends with methacryloxypropyl, and the like.

### [Siloxane Mass % in the Composition]

Preferably, regarding component (B2), the curable organopolysiloxane composition according to the present invention includes component (A) which is a chain-like reactive siloxane component, and optionally (B2) an organopolysiloxane compound with an organic group that includes at least one acryl group or methacryl group in each molecule. The ratio of the sum of the mass of component (A) and component (B2), which account for the total mass of solid content of the composition (components that form the organopolysiloxane adhesive layer by curing, excluding organic solvents) can be defined as the “siloxane mass % in the composition,” and if the siloxane mass % is within a range of 50 mass % or more, preferably 55 to 99.5 mass %, or more preferably 60 to 99.5 mass %, the organopolysiloxane adhesive layer of the present invention can be designed to have a transparent appearance, flexibility unique to silicone, and slight adhesiveness derived from the viscoelastic properties of the cured product.
[Organopolysiloxane Resins Other than Component (A) and Component (B2)]
The composition according to the present invention may include organopolysiloxane resins other than component (A) and component (B2), as long as the slight adhesiveness, which is the technical effect of the present invention, can be achieved. This type of organopolysiloxane resin is a component that adjusts adhesive strength, that is, the ability to adhere to a substrate, and depending on the amount of the component used, can adjust the hardness of a cured product of the composition and the adhesion to the substrate.

Examples of such an organopolysiloxane resin include organopolysiloxane resins that include a siloxane unit (M unit) expressed by R₃SiO_{1/2} (where R mutually independently represents a monovalent organic group) and a siloxane unit (Q unit) expressed by SiO_{4/2} in each molecule. Here, the molar ratio of M units to Q units may be 0.5 to 2.0. This is because when the molar ratio is less than 0.5, adhesion to the substrate of the cured product may be reduced, whereas when the molar ratio is greater than 2.0, the cohesive strength of material forming the adhesive layer decreases.

On the other hand, from the viewpoint of slight adhesiveness, it is preferable that the curable organopolysiloxane composition according to the present invention include little, or substantially no organopolysiloxane resin described above. Specifically, the curable organopolysiloxane composition according to the present invention preferably has a mass ratio of the organopolysiloxane resin (=[mass of organopolysiloxane resin]/[sum of the masses of component (A)+component (B2)]) in a range of 0 to 0.1 with respect to the sum of component (A), which is a chain-like reactive siloxane component, and component (B2), which will be described later; more preferably the mass ratio is in the range of 0 to 0.05; and most preferably the mass ratio is 0, that is, that the composition includes substantially no organopolysiloxane resin. If the content of the organopolysiloxane resin exceeds the above upper limit, there will be stronger adhesion and adhesive strength, as derived from the organopolysiloxane resin, with respect to the organopolysiloxane adhesive layer after curing, making it possible that a slightly adhesive layer can not be achieved.

### [Component (C)]

Component (C) is a radical polymerization initiator, and may be a photoradical polymerization initiator (C1), a thermal radical polymerization initiator (C2), or a combination thereof, and the type of component (C), curing method, and curing temperature may be selected as appropriate based on the curing and adhesion processes for the curable organopolysiloxane composition according to the present invention, heat resistance of the substrate, demand for low energy consumption, and the like. The composition according to the present invention has an alkenyl group in component (A) serving as a main agent, and thus favorable curability can be achieved by irradiation with a high-energy beam and/or heating in the presence of component (C).

When the mass of component (A) is 30 to 99 parts by mass, the amount of component (C) used is 0.1 to 10 parts by mass, with the particularly preferable amount thereof being 0.2 to 5 parts by mass. It should be noted that the amount of component (C) to be used can be appropriately designed within the above range based on the forming process and curing time of the adhesive layer formed by the present composition, the amount of alkenyl groups derived from component (A), the high-energy beam irradiation dose, and/or the heating conditions.

Component (C1) is a photoradical polymerization initiator, and is a component that promotes the photocuring reaction of the alkenyl group in component (A), and optionally a thiol compound (E), through high-energy beam irradiation of UV rays and the like.

The photoradical polymerization initiators are known to be broadly classified into photo-fragmentation and hydrogen abstraction types. However, the photoradical polymerization initiator used in the composition of the present invention can be optionally selected from those known in the technical field, and is not limited to any particular one. Note that some photoradical polymerization initiators can promote curing reactions not only when irradiated with a high energy beam such as ultraviolet rays, and the like, but also when irradiated with light in the visible light range.

Specific examples of the photoradical polymerization initiator include α-ketol compounds such as 4-(2-hydroxyethoxy)phenyl (2-hydroxy-2-propyl) ketone, α-hydroxy-α, α′-dimethylacetophenone, 2-methyl-2-hydroxypropiophenone, 1-hydroxycyclohexyl phenyl ketone, and the like; acetophenone compounds such as methoxyacetophenone, 2,2-dimethoxy-2-phenylacetophenone, 2,2-diethoxyacetophenone, 2-methyl-1-[4-(methylthio)-phenyl]-2-morpholinopropane-1, and the like; benzoin ether compounds such as benzoin ethyl ether, benzoin isopropyl ether, anisoin methyl ether, and the like; ketal compounds such as benzyl dimethyl ketal and the like; aromatic sulfonyl chloride compounds such as 2-naphthalenesulfonyl chloride and the like; photoactive oxime compounds such as 1-phenone-1,1-propanedione-2-(o-ethoxycarbonyl)oxime and the like; benzophenone compounds such as benzophenone, benzoylbenzoic acid, 3,3′-dimethyl-4-methoxybenzophenone, and the like; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and the like; camphorquinone; halogenated ketones; and the like.

Similarly, examples of suitable photoradical polymerization initiators that can be used as component (C1) in the present invention can include bisacylphosphine oxides such as bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propyl phenylphosphine oxide, bis(2,4,6-trimethylbenzoyl)-phenylphosphine oxide, bis(2,6-dimethoxybenzoyl)-2,4,4-trimethylpentylphosphine oxide, bis(2,6-dichlorbenzoyl)-4-propylphenylphosphine oxide, bis(2,6-dichlorobenzoyl)-2,5-dimethylphenylphosphine oxide, bis-(2,6-dimethoxybenzoyl)-2,5-dimethylphenylphosphine oxide, bis-(2,4,6-trimethylbenzoyl)-phenylphosphine oxide, and the like; monoacylphosphine oxides such as 2,6-dimethoxybenzoyldiphenylphosphine oxide, 2,6-dichlorobenzoyldiphenylphosphine oxide, 2,4,6-trimethylbenzoylphenylphosphine acid methyl ester, 2-methylbenzoyldiphenylphosphine oxide, pivaloylphenylphosphinic acid isopropyl ester, 2,4,6-trimethylbenzoyldiphenylphosphine oxide, and the like; anthraquinones such as anthraquinone, chloroanthraquinone, 2-methylanthraquinone, 2-ethylanthraquinone, 2-tert-butylanthraquinone, 1-chloroanthraquinone, 2-amylanthraquinone, 2-aminoanthraquinone, and the like; benzoic acid esters such as ethyl-4-dimethylaminobenzoate, 2-(dimethylamino)ethylbenzoate, p-dimethylbenzoic acid ethyl ester, and the like; titanocenes such as Bis(η5-2,4-cyclopentadien-1-yl)-bis(2,6-difluoro-3-(1H-pyrrol-1-yl)phenyl)titanium, bis(cyclopentadienyl)-bis[2,6-difluoro-3-(2-(1-pyl-1-yl)ethyl)phenyl]titanium, and the like; phenyl disulfide 2-nitrofluorene; butyroin; anisoin ethyl ether; azobisisobutyronitrile; tetramethylthiuram disulfide, and the like.

Examples of commercially available acetophenone photopolymerization initiators suitable as component (C1) in the present invention include Omnirad 907, 369, 369E, 379, and the like, produced by IGM Resins, Inc. Furthermore, examples of commercially available acylphosphine oxide photopolymerization initiators include Omnirad TPO, TPO-L, 819, and the like, produced by IGM Resins, Inc. Examples of commercially available oxime ester photopolymerization initiators include Irgacure OXE01 and OXE02 manufactured by BASF Japan Co., Ltd., N-1919, Adeka ARKLS NCI-831, and NCI-831E manufactured by ADEKA Co., Ltd., TR-PBG-304 manufactured by Changzhou Tronly New Electronics Materials Co., Ltd., and the like.

Component (C2) is a thermal radical polymerization initiator that generates radical species when heated and promotes thermosetting reactions of alkenyl groups in component (A), and optionally a thiol compound (E). Examples of such thermal radical polymerization initiators include azo compounds, organic peroxides, and the like.

Examples of azo compounds include 2,2′-azobisisobutyronitrile, 2,2′-azobis(2-methylbutyronitrile), 2,2′-azobis(2,4-dimethylvaleronitrile), 1,1′-azobis-1-cyclohexanecarbonitrile, dimethyl-2,2′-azobisisobutyrate, dimethyl-2,2′-azobis(2-methylpropionate), dimethyl-1,1′-azobis(1-cyclohexanecarboxylate), 4,4′-azobis(4-cyanovaleric acid), 2,2′-azobis(2-amidinopropane) dihydrochloride, 2-tert-butylazo-2-cyanopropane, 2,2′-azobis(2-methylpropionamide) dihydrate, 2,2′-azobis(2,4,4-trimethylpentane), and the like.

Examples of organic peroxides include alkyl peroxides, diacyl peroxides, ester peroxides, and carbonate peroxides. Specific examples of alkyl peroxides include dicumyl peroxide, di-tert-butyl peroxide, di-tert-butylcumyl peroxide, 2,5-dimethyl-2,5-di(tert-butylperoxy)hexane, 2,5-dimethyl-2,5-di(tert-butylperoxy)hexyne-3, tert-butylcumyl, 1,3-bis(tert-butylperoxyisopropyl)benzene, and 3,6,9-triethyl-3,6,9-trimethyl-1,4,7-triperoxonan.

Examples of diacyl peroxides include benzoyl peroxide, lauroyl peroxide, and decanoyl peroxide. Examples of ester peroxides include 1,1,3,3-tetramethylbutylperoxyneodecanoate, α-cumylperoxyneodecanoate, tert-butylperoxyneodecanoate, tert-butylperoxyneoheptanoate, tert-butylperoxypivalate, tert-hexylperoxypivalate, 1,1,3,3-tetramethylbutylperoxy-2-ethylhexanoate, tert-amylperoxyl-2-ethylhexanoate, tert-butylperoxy-2-ethylhexanoate, tert-butylperoxyisobutyrate, di-tert-butylperoxyhexahydroterephthalate, tert-amylperoxy-3,5,5-trimethylhexanoate, tert-butylperoxy-3,5,5-trimethylhexanoate, tert-butylperoxyacetate, tert-butylperoxybenzoate, and di-butylperoxytrimethyladipate. Examples of carbonate peroxides include di-3-methoxybutyl peroxydicarbonate, di(2-ethylhexyl)peroxydicarbonate, diisopropyl peroxycarbonate, tert-butyl peroxyisopropylcarbonate, di(4-tert-butylcyclohexyl)peroxydicarbonate, dicetyl peroxydicarbonate, and dimyristyl peroxydicarbonate.

### [Component (C′): Photosensitizer]

In the present composition, a photosensitizer (C′) may be used in combination with an optionally selected photoradical polymerization initiator (C1). Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. Examples of known sensitizers include anthracene-based compounds, phenothiazine-based compounds, perylene-based compounds, cyanine-based compounds, melocyanine-based compounds, coumarin-based compounds, benzylidene ketone-based compounds, and (thio)xanthene or (thio)xanthone-based compounds such as isopropylthioxanthone, 2,4-diethylthioxanthone, squarylium-based compounds, (thia)pyrylium-based compounds, porphyrin-based compounds, and the like. Moreover, an arbitrary photosensitizer not limited thereto can be used in the curable organopolysiloxane composition and adhesive composition of the present invention. The amount used is arbitrary, but is commonly selected within a range where the mass ratio of component (C′) to component (C1) is 0 to 10, and if present, is within a range of 0.01 to 5.

### [Selection of and Curing Method for Component (C)]

Because the present composition includes the above-mentioned components (A) and (B), a cured product is formed by a radical polymerization reaction. Here, when at least a part of component (C) is (C1), which is a photoradical polymerization initiator, the present composition can be cured by irradiation with a high energy beam such as ultraviolet rays, and the like. Similarly, when at least a portion of component (C) is (C2), which is a thermal radical polymerization initiator, the present composition can be cured by heating. Furthermore, combining the two makes it possible to select or combine heating and high-energy irradiation for curing, and the appropriate selection can be made based on the desired curing method and sealing process.

With respect to the composition of the present invention in particular, at least a portion of component (C) includes (C1), which is a photoradical polymerization initiator, and also optionally (C′), which is a photosensitizer, so the environmental impact is low and a rapid curing reaction can be performed even at low temperature including room temperature, even for substrates and components with poor heat resistance, which thus provides an advantage in that the component can be suitably used in industrial production processes that respond to energy reduction in the field of semiconductors, and the like. On the other hand, when at least a part of the component (C) is the thermal radical polymerization initiator (C2), this provides an advantage in which rapid curing is possible in a short time at high temperatures.

### [(D) Organic Solvent and Low-Solvent/Solvent-Free Composition]

The curable organopolysiloxane composition of the present invention, can be designed as a low-solvent or solvent-free type composition by selecting constituent components thereof (particularly by selecting structural components with low viscosity as the entire component (A)), and thus it is possible to design a composition that has adequate coating properties for practical use, even if the composition contains only a small amount of (D), which is an organic solvent, or substantially no organic solvents. Specifically, the amount of organic solvent is less than 0 to 60 mass %, particularly preferably less than 50%, and substantially in a range of 0 to 30%, based on the total mass of the composition of 100 parts by mass. On the other hand, a small amount of organic solvent may be included if unavoidable in order to improve the wettability of the present composition to the substrate, or as a solvent associated with other components. The type and amount of organic solvent should be adjusted in consideration of coating workability, and the like. However, from the perspective of designing a solvent-free composition, it is preferable to use as little organic solvent as possible.

More specifically, when the total amount (=sum) of components (A) to (C), and optionally other non-volatile components that form the solid content of the curable organopolysiloxane composition of the present invention upon curing, is 100 parts by mass, the total amount of component (D), which is a diluent, is in the range of 0 to 100 parts by mass, and preferably in the range of 0 to 25 parts by mass.

Examples of the organic solvent (D) of the present invention include: aromatic hydrocarbon-based solvents such as toluene, xylene, and benzene; aliphatic hydrocarbon-based solvents such as heptane, hexane, octane, and isoparaffin; ester-based solvents such as ethyl acetate and isobutyl acetate; ether-based solvents such as diisopropyl ether and 1,4-dioxane; chlorinated aliphatic hydrocarbon-based solvents such as trichloroethylene, perchloroethylene, and methylene chloride; and solvent volatile oils, with two or more types capable of being combined in accordance with the wettability of the sheet-like substrate or the like.

### [(E) Thiol Compound]

The composition according to the present invention may further contain (E) a polyfunctional thiol compound having at least two or more thiol groups (—SH) in a molecule. The polyfunctional thiol compound acts as a chain transfer agent to promote a radical polymerization reaction, and is able to improve curing speed and deepen curability of a cured product, and to function as a crosslinking point in the present composition, particularly when a part of component (C) according to the present invention is a photoradical polymerization initiator and the present composition is cured by irradiation with a high energy beam such as ultraviolet rays, and the like, even when the irradiation dose of the high energy beam is small.

Examples of the polyfunctional thiol compound include pentaerythritol tetrakis(3-mercaptobutyrate), 1,4-bis(3-mercaptobutyryloxy)butane, 1,3,5-tris(2-(3-sulfanylbutanoyloxy)ethyl)-1,3,5 triazinane-2,4,6-trione, trimethylolpropane tris(3-mercaptobutyrate), and the like.

Furthermore, component (E) may be an organopolysiloxane compound having an organic group containing at least two thiol groups in a molecule, and any resin-like, chain-like (including linear and branched), cyclic, or resin-linear block copolymer including a resinous block and a chain block can be used. In the thiol group-containing organopolysiloxane compound serving as component (E), the bonding site of the thiol-modifying group is not particularly limited, and thus may be either at a molecular chain end or side chain. An example thereof is a linear organopolysiloxane with a thiol-modifying group at a side chain site, such as a dimethylsiloxane/2-thiolpropylmethylsiloxane copolymer blocked at a molecular chain end thereof with a trimethylsiloxy group, and the like. In particular, when component (E) is a thiol group-containing organopolysiloxane compound, compatibility with other structural components and the uniformity and viscosity of the entire composition can be improved, and in some cases, the cross-linking density within molecules can be adjusted.

The use of component (E) is optional, the amount thereof is 0 to 20 parts by mass relative to 50 to 99 parts by mass of component (A), preferably 0 to 10 parts by mass, and particularly preferably 0 to 5 parts by mass.

### [(A′) Chain Organopolysiloxane not Containing a Carbon-Carbon Double Bond-Containing Reactive Group in a Molecule]

Non-reactive organopolysiloxanes such as polydimethylsiloxane or polydimethyldiphenylsiloxane that do not contain reactive groups that include carbon-carbon double bonds such as alkenyl groups, acrylic groups, and methacrylic groups, and the like, can be blended with the curable organopolysiloxane composition of the present invention groups, which may make it possible to improve the loss coefficient (tan δ), storage elastic modulus (G′), and loss modulus (G″) of the organopolysiloxane adhesive layer. For example, the loss coefficient of the cured product layer can be increased by using a polydimethylsiloxane or polydimethyldiphenylsiloxane having a hydroxyl group terminal, with such compositions included within the scope of the present invention.

The curable organopolysiloxane composition of the present invention may optionally contain components other than the components described above, to an extent that does not impair the technical effects of the present invention. For example, the composition may contain: an adhesion promoter; an antioxidant such as a phenol-type, a quinone-type, an amine-type, a phosphorus-type, a phosphite-type, a sulfur-type, or a thioether-type antioxidant; a light stabilizer such as triazoles or benzophenones; a flame retardant such as a phosphate ester-type, a halogen-type, a phosphorus-type, or an antimony-type flame retardant; and one or more types of antistatic agents including cationic surfactants, anionic surfactants, non-ionic surfactants, and the like; a polymerization inhibitor; a UV absorber; or the like. Note that in addition to these components, pigments, dyes, inorganic microparticles that may be optionally surface-treated (reinforcing fillers, dielectric fillers, electrically conductive fillers, thermally conductive fillers), and the like can also be optionally added.

The method of preparing the curable organopolysiloxane composition of the present invention is not particularly limited and is performed by homogeneously mixing the respective components. An organic solvent may be added as necessary, and the composition may be prepared by mixing using a known stirrer or kneader. Note that depending on the type of component (C), the present composition may have radical polymerizing properties when heated, and thus in such cases, mixing is preferred at a temperature less than 200° C., and preferably less than 150° C.

### [Viscosity of the Entire Composition]

From the perspective of coatability and handling workability as an adhesive or an adhesive-forming composition, the viscosity of the entire curable organopolysiloxane composition of the present invention at 25° C. is in the range of 1000 to 300000 mPa·s, and preferably in the range of 5000 to 50000 mPa·s. In particular, when the amount of organic solvent is 30 mass % or less with regard to 100 parts by mass of the composition, the viscosity of the entire composition is preferably in a range of 5000 to 300000 mPa·s. This type of composition can achieve practical sufficient coating properties even if the composition is a low-solvent or solvent-free type.

### [Method of Use as Adhesive Layer]

The curable organopolysiloxane composition of the present invention contains the above-mentioned component (A), component (B), and component (C), so the composition can be cured by one or more radical polymerization reactions selected from, (i) a heat curing reaction, and (ii) a photocuring reaction by irradiation with a high-energy beam. Here, an organopolysiloxane adhesive layer with adhesive strength with respect to a substrate can be formed even when in the form of a cured product where a curing reaction is completed or in the form of a semi-cured product that retains curing reactivity as a composition. Therefore, the expression “curing or semi-curing a curable organopolysiloxane composition” used in the present invention refers to a state in which a radical polymerization reaction is completed in an organopolysiloxane adhesive layer as “cured” and refers to a state in which solid organopolysiloxane adhesive layer has been formed, but a state in which the adhesive layer retains radical polymerization reactivity and can undergo further curing reaction by heating and irradiation with a high-energy beam as “semi-cured.” Note that a reaction for forming a semi-cured organopolysiloxane adhesive layer, and a subsequent reaction for forming a cured organopolysiloxane adhesive layer may be the same or different radical polymerization reaction, and two or more types of radical polymerization reactions may be performed simultaneously. As an example, the semi-cured organopolysiloxane adhesive layer may be formed by a heat curing reaction, and then the fully cured organopolysiloxane adhesive layer may be formed by irradiation with a high-energy beam, or the semi-cured and fully-cured organopolysiloxane adhesive layers may be formed by the same curing reaction performed in stages by temporarily interrupting and then restarting heating or irradiation with high-energy irradiation.

Here, the organopolysiloxane adhesive layer in the “semi-cured” state undergoes further progress of one or more radical polymerization reactions selected from, (i) a heat curing reaction and, (ii) a photocuring reaction by irradiation with a high-energy beam. In some cases, the crosslinking density of the adhesive layer changes when changing to the “cured” state, thereby changing the adhesive strength with respect to a substrate. For example, by allowing the radical polymerization reactions described above to proceed and cure the organopolysiloxane adhesive layer in the “semi-cured” state while the layer is in contact with the substrate, the fully cured adhesive layer may exhibit stronger adhesive strength to the substrate, and thus form a stronger bonded body. On the other hand, if the crosslinking density of the organopolysiloxane adhesive layer increases due to curing, the adhesive strength with respect to the substrate will decrease and thus reduce the adhesive force with respect to the substrate from the time of contact, possibly changing to a state where the layer can be easily peeled off. The former case is particularly advantageous when forming a permanent adhesive layer as a bonding layer between substrates, while the latter case is advantageous when the adhesive strength of the adhesive layer must be reduced so that the layer can be easily peeled from the substrate by being irradiated with a high-energy beam, or the like, in a later process by functioning in a process as a slightly adhesive layer that temporarily adheres substrates together such as, for example, a process protective film. These methods of use that include changes in adhesiveness are those clearly intended and taught by the applicants of the curable organopolysiloxane composition and the organopolysiloxane adhesive layer of the present invention.

### [Application and Curing]

The curable organopolysiloxane composition of the present invention forms a coating film when coated onto a substrate and forms an organopolysiloxane adhesive layer that is a cured product or semi-cured product by one or more radical polymerization reactions selected from, (i) a heat curing reaction, and (ii) a photocuring reaction by irradiation with a high-energy beam.

Examples of application methods include gravure coating, offset coating, offset gravure, roll coating, reverse roll coating, air knife coating, curtain coating, and comma coating. The coating amount can be designed at a desired thickness in accordance with the application such as an adhesive layer, a display device, or the like. For example, the thickness of the adhesive layer after curing may be from 1 to 1000 μm, from 5 to 900 μm, or from 10 to 800 μm. However, there is no limitation thereto.

When cured by the (i) heat curing reaction, the curable organopolysiloxane composition according to the present invention provides an adhesive layer that is either a slightly adhesive cured product or semi-cured product by a thermal radical polymerization reaction by heating under temperature conditions of 80 to 200° C., preferably 100° C. or higher, and more preferably 100 to 180° C. Note that the heating time required for curing can be selected as appropriate depending on the degree of curing, the thickness of the adhesive layer, and the amount of catalyst used, but the time is generally in a range of 0.5 to 90 minutes, and an organopolysiloxane adhesive layer in the form of a semi-cured product that retains heat curing reactivity may be obtained by heating intermittently or in stages. Note that the heating temperature and heating time may be appropriately selected based on the heat resistance of the substrate, the sealing process, and the like.

When the curable organopolysiloxane composition of the present invention is cured by the (ii) photocuring reaction by irradiation with a high-energy beam, examples of usable high-energy beams include ultraviolet rays, gamma rays, X-rays, alpha beams, electron beams, and the like, but ultraviolet rays are preferred from the perspective of practicality. As the UV ray generating source, a high-pressure mercury lamp, a medium-pressure mercury lamp, a Xe—Hg lamp, a deep UV lamp, or the like is suitable, and in particular, UV ray irradiation with a wavelength of 280 to 400 nm, preferably with a wavelength of 300 to 400 nm is preferable, and a light source with a plurality of light emission bands may be used.

Although the high-energy beam irradiation dose varies depending on the type and amount of the photoradical polymerization initiator (C1) and the degree of curing reaction, when ultraviolet rays are used, the cumulative irradiation amount at a wavelength of 365 nm is preferably within the range of 100 mJ/cm² to 100 J/cm². Note that the high energy beam irradiation may be performed with the substrate sandwiched in between, so long as the substrate supporting the adhesive layer of the present invention does not absorb electromagnetic waves in the above wavelength region. In other words, if a certain amount of irradiation is feasible, high energy beam irradiation may be performed over a cover material such as a substrate, protective film, or the like.

The curing reaction does not require heating, and therefore curing can be performed at a low temperature (15 to 100° C.), including room temperature (25° C.). Note that in an embodiment of the present invention, “low temperature” refers, for example, to 100° C. or lower, specifically, a temperature range of 15° C. to 100° C., and even temperatures of 80° C. or lower can be selected. When the reaction of the composition (including a semi-cured product) of the present invention proceeds in the temperature range of 15 to 100° C., the present composition may suitably be left at or near room temperature range (a temperature range that can be reached without heating or cooling, particularly including a temperature region of 20 to 25° C.), may be cooled to 15° C. to room temperature, or may be heated to room temperature or higher and 100° C. or lower. Note that the time required for the curing reaction can be designed as appropriate based on the irradiation dose of a high-energy beam of UV rays or the like and the temperature. Additionally, an organopolysiloxane adhesive layer in the form of a semi-cured product that retains photocuring reactivity may be obtained by interrupting irradiation before a predetermined cumulative irradiation dose is reached.

The organopolysiloxane adhesive layer obtained by the curing reaction described above is slightly adhesive. For example, an layer can be designed such that adhesiveness of a 55 μm thick cured product layer to a 2 mm thick polymethyl methacrylate sheet, measured at a tensile rate of 300 mm/min using the 180° peel test method according to JIS Z 0237 is in the range of 5 to 50 gf/25 mm, and preferably in the range of 5 to 40 gf/25 mm. Note that the thickness (55 μm) described above is the thickness of the cured layer itself serving as a reference for objectively defining the adhesiveness of the cured layer according to the present invention. It goes without saying that the curable organopolysiloxane composition of the present invention is not limited to a thickness of 55 μm and may be used as a cured layer or an adhesive layer of an arbitrary thickness.

### [Use of Cured Product]

The cured product and semi-cured product according to the present invention are slightly adhesive and can be used as an organopolysiloxane adhesive layer or an elastic adhesive member. Here, in order to improve the adhesion between an adherend and the adhesive layer, the adhesive layer or the substrate may be subjected to a surface treatment such as a primer treatment, corona treatment, etching treatment, plasma treatment, or the like.

The curable organopolysiloxane composition of the present invention is cured by applying the composition to a release liner, then heating under the temperature conditions described above, and after the release liner is peeled off and the composition is attached to a film-like substrate, a tape-like substrate, or a sheet-like substrate (hereinafter, referred to as a “film-like substrate”) or applied to a film-like substrate, curing by heating at the temperature conditions described above can be performed to form an adhesive layer on the surface of the substrate. A laminate body provided with a cured layer, in particular, a film-like adhesive layer, obtained by curing the organopolysiloxane composition according to the present invention on these film-like substrates may be used for adhesive tapes, adhesive bandages, low-temperature supports, transfer films, labels, emblems, and decorative or explanatory signs. Further, a cured layer obtained by curing the organopolysiloxane composition according to the present invention may be used to assemble automobile parts, toys, electronic circuits, or keyboards. Alternatively, the cured layer obtained by curing the organopolysiloxane composition of the present invention, particularly in the form of a film-like adhesive layer, may also be used to construct and utilize laminated touch screens or flat panel displays.

Examples of the substrates include paperboard, cardboard, clay coated paper, polyolefin laminated paper, especially polyethylene laminated paper, synthetic resin films/sheets, natural fiber cloth, synthetic fiber cloth, artificial leather cloth, and metal foil. In particular, synthetic resin films and sheets are preferable, and examples of synthetic resins include polyimides, polyethylenes, polypropylenes, polystyrenes, polyvinyl chlorides, polyvinylidene chlorides, polycarbonates, polyethylene terephthalates, cyclopolyolefins, and nylons. When heat resistance is required in particular, a heat-resistant synthetic resin film such as a polyimide, polyetheretherketone, polyethylene naphthalate (PEN), liquid crystal polyacrylate, polyamide-imide, polyether sulfone, and the like is preferable. At the same time, for applications such as a display device in which visibility is required, a transparent substrate and specifically a transparent material such as a polypropylene, polystyrene, polyvinylidene chloride, polycarbonate, polyethylene terephthalate, PEN, and the like is preferable.

The substrate is preferably a film-like or sheet-like substrate. The thickness thereof is not particularly limited and can be designed with a desired thickness in accordance with the application. Furthermore, in order to improve the adhesion between a supporting film and the adhesive layer, a supporting film subjected to a primer treatment, corona treatment, etching treatment, or plasma treatment may be used. Furthermore, the opposite surface of the film-like substrates from the adhesive layer surface may be subjected to surface treatment such as anti-scratch, anti-dirt, anti-fingerprint, anti-glare, anti-reflection, anti-static treatments and the like.

The adhesive layer according to the present invention may be a single layer or a multilayer structure obtained by laminating two or more adhesive layers in accordance with required properties. A multilayer adhesive layer may be formed by bonding together adhesive films formed layer by layer, or by performing the step of applying and curing the curable organopolysiloxane composition according to the present invention a plurality of times on a film substrate, or the like, provided with a release layer.

Because the adhesive layer of the present invention has a function to create adhesion or adhesiveness between members, the layer can be expected to function as an elastic adhesive member. Furthermore, the adhesive layer may play a role as another functional layer selected from a dielectric layer, a conductive layer, a heat dissipation layer, an insulating layer, a reinforcing layer, and the like. Additionally, when the above curing reaction is performed in a plurality of stages and the change in adhesiveness accompanying the change from a semi-cured product to a cured product is utilized, the layer may be used as an easily releasable adhesive layer for temporary attaching.

When the cured layer obtained by curing the curable organopolysiloxane composition according to the present invention is an adhesive layer, especially a pressure-sensitive adhesive/slightly adhesive film, the cured layer is preferably handled as a laminate film peelably adhered on a film substrate provided with a release layer having release coating capabilities. The release layer may also be referred to as a release liner, a separator, a release layer, or a release coating layer, and may preferably be a release layer having a release coating ability such as a silicone-based release agent, a fluorine-based release agent, an alkyd-based release agent, or a fluorosilicone-based release agent, or it may be formed as a substrate itself which is not prone to adhering to the resin sheet for an adhesive layer of the present invention by forming physically fine irregularities in the surface of the substrate. Furthermore, a release layer formed by curing a fluorosilicone-based release agent may be used in the laminate body of the present invention as a release layer. Note that in the aforementioned laminate body, the release layer may be a different release layer, which is a first release layer and a second release layer having different types of release agents and different release forces configuring the release layer. The fluorosilicone-based release agent may be a curing reactive silicone composition containing one or more types of fluorine-containing groups selected from fluoroalkyl groups and perfluoropolyether groups.

Because the cured product obtained by curing the curable organopolysiloxane composition of the present invention has both the above-mentioned viscoelasticity and slight adhesiveness, the product is useful as an elastic adhesive member and as a member for various electronic or electrical devices. In particular, the cured product is useful as an electronic material, a member for a display device, or a member for a transducer (including sensors, speakers, actuators, and generators), and a preferable application for the cured product is a member of an electronic part or display device. Because the cured product of the present invention has superior transparency, the cured product, in the form of a film, particularly a substantially transparent adhesive film, is suitable as a member for a display panel or display, and is thus particularly useful for so-called touch panel applications in which devices, especially electronic devices, can be operated by touching a screen with a fingertip or the like. It should be noted that the present elastic adhesive layer is particularly useful for film-like or sheet-like members used in sensors, speakers, actuators, and the like, where transparency is not required and the adhesive layer itself is required to have a certain degree of elasticity or flexibility.

In addition, because an adhesive layer formed by curing the curable organopolysiloxane composition can be designed to be low-solvent or solvent-free and can achieve adhesive properties that are slightly adhesive or easy peeling, the layer can improve adhesion to substrates for display devices and the like. Additionally, using a semi-cured product or a multi-step curing reaction, as desired, gives the layer the advantage of being usable as an easily releasable adhesive layer to be temporarily fixed to a display device, semiconductor, or the like, as a functional film (for example, a protective film) used temporarily under the assumption of being attached and detached.

### [Use as Tape]

Articles that include the adhesive layer formed by curing the curable organopolysiloxane composition of the present invention may include adhesive tape, especially protective tape intended to be attached and detached, and are characterized by providing sheet-like members made of textile products such as the aforementioned synthetic resin films/sheets, metal foil, woven fabric, non-woven fabric, paper, or the like, and the aforementioned adhesive layer. The type of adhesive tape is not particularly limited, and includes insulating tapes, heat-resistant tapes, solder masking tapes, mica tape binders, temporary attaching tapes (including in particular temporary attaching tapes for silicone rubber parts, and the like), and splicing tapes (including in particular splicing tapes for silicone release paper).

### [Adhesive Sheet]

A laminate body having an adhesive layer formed by curing the curable organopolysiloxane composition according to the present invention may be formed on the aforementioned film-like substrates, and preferably, these film-like substrates may be provided with a release layer for the cured adhesive layer.

The laminate body with the aforementioned form preferably includes a sheet-like substrate with at least one release layer, and the release layer is preferably in contact with the cured adhesive layer. Thereby, the adhesive layer according to the present invention can be easily peeled from the sheet-like substrate. The release agent included in the release layer is not particularly limited, and examples may include the same release agents as described above.

In particular, the laminate body may be able to handle the adhesive layer separated from the film-like substrate alone, or there may be two film-like substrates.

Specifically, the laminate body may have:
a film-like substrate;
a first release layer formed on the film-like substrate;
an adhesive layer formed by applying, and curing the curable organopolysiloxane composition on the release layer; and
a second release layer laminated on the adhesive layer.

Similarly, the laminate body of the above form may be formed, for example, by coating and curing the curable organopolysiloxane composition described above on one of the release layers formed on the film-like substrates to form an adhesive layer, and then laminating another release layer on the adhesive layer.

Preferably, the laminate body of the above form can be produced by a manufacturing method that includes:
step (L1-I): a step of applying the curable organopolysiloxane composition of the present invention onto a film-like substrate which may optionally have a release layer;
step (L1-II): a step or curing or semi-curing the curable organopolysiloxane composition applied in step (L1-I) by at least one type of curing reaction, selected from (i) a heat curing reaction and, (ii) a photocuring reaction by irradiation with a high-energy beam; and optionally
step (L1-III): a step of laminating another substrate onto the organopolysiloxane adhesive layer formed in step (L1-II).
   Here, the first substrate used in step (L1-I) is preferably a film-like substrate provided with a first release layer on the surface thereof, and the other substrate used in step (L2-III) is preferably a film-like substrate with a second release layer on the surface thereof.

Furthermore, a laminate body with this form may be produced, for example, by interposing the curable silicone composition described above between the first film-like substrate and the second film-like substrate, to form a layer to a certain thickness by pressing or rolling while heating, and then curing the composition.

The first sheet substrate may be provided with a first release layer, or the first sheet substrate itself may be provided with releasability. Similarly, the second sheet substrate may be provided with a second release layer, or the second sheet substrate itself may be provided with releasability. When the first sheet substrate and/or the second sheet substrate is provided with a first release layer and/or a second release layer, the cured adhesive layer is preferably in contact with the first release layer and/or the second release layer.

For example, the sheet substrate having releasability includes a sheet substrate made of a material having releasability such as a fluororesin film, or a sheet substrate made of a material having no or low releasability such as a polyolefin film to which a release agent such as silicone, fluororesin, or the like has been added. On the other hand, the sheet substrate provided with the release layer includes, for example, a polyolefin film and the like, coated with a release agent such as silicone, fluororesin, or the like.

The aforementioned laminate body can be used, for example, by peeling the adhesive layer from the film-like substrate after applying the cured adhesive layer to the adherend.

The thickness of the adhesive layer (cured adhesive layer) is preferably 5 to 10000 μm, preferably 10 μm or more or 8000 μm or less, and particularly preferably 20 μm or more and 5000 μm or less.

### [Members for Semiconductors, Electronic Components, Batteries, Display Panels, or Displays]

The curable organopolysiloxane composition or the organopolysiloxane adhesive layer formed by semi-curing according to the present invention can be used as a slightly adhesive layer associated with manufacturing a laminate body other than the releasable laminate body described above. Specifically, the organopolysiloxane pressure-sensitive adhesive layer of the present invention can be used to protect, construct, and use electronic components such as semiconductors (including semiconductor precursors and integrated semiconductor devices such as LSI, MEMS, and the like); semiconductor substrates (including flexible substrates and stretchable substrates such as wearable devices, and the like); batteries such as secondary batteries, and the like; and display panels or displays such as laminated touch screens or flat panel displays, and the like; and, as for specific methods, any known method of using an adhesive layer (for example, silicone PSAs, silicone adhesives, and silicone sealants) can be used without particular limitation.

The method for manufacturing a laminate body for semiconductors, and the like is not particularly limited as long as an organopolysiloxane adhesive layer is used for adhesion between members, and an organopolysiloxane adhesive layer that has already been cured or semi-cured may also be used. For example, when manufacturing a laminate body for a semiconductor, or the like, a releasable member on one or both sides of the organopolysiloxane adhesive layer of the laminate body (for example, one-sided or double-sided adhesive film) that includes the organopolysiloxane adhesive layer described above may be peeled off first, then a substrate for forming a laminate body for a semiconductor, or the like, may be brought into close contact with the exposed organopolysiloxane adhesive layer to form a laminate body (including precursors and temporary adhering for the purpose of protection during the process) for a semiconductor, or the like.

On the other hand, the laminate body for a semiconductor, or the like, of the present invention may be used to form an organopolysiloxane adhesive layer by applying an uncured curable organopolysiloxane composition on or between the substrates, and then curing or semi-curing the composition.

For example, the laminate body of the present invention can be obtained by a manufacturing method for a laminate body, including:
step (L2A-I): a step of applying the curable organopolysiloxane composition of the present invention on a first substrate;
step (L2A-II): a step of curing or semi-curing the curable organopolysiloxane composition applied in step (L2A-I) by at least one type of curing reaction selected from, (i) a heat curing reaction and, (ii) a photocuring reaction by irradiation with a high-energy beam; and optionally,
step (L2A-III): a step of laminating another substrate on an organopolysiloxane adhesive layer formed in step (L2A-II).
   The present method forms an organopolysiloxane adhesive layer on one of the substrates, and laminates the other substrate thereon.

Similarly, the laminate body of the present invention can be obtained by a method for manufacturing a laminate body including:
step (L2B-I): a step of applying the curable organopolysiloxane composition of the present invention on a first substrate;
step (L2B-II): a step of laminating another substrate on the curable organopolysiloxane composition applied in step (L2B-I); and
step (L2B-III): a step of curing or semi-curing the uncured curable organopolysiloxane composition between substrates for the laminate body precursor formed in step (L2B-II) by at least one type of curing reaction selected from, (i) a heat curing reaction and, (ii) a photocuring reaction by irradiation with a high-energy beam.
   The present method forms the organopolysiloxane adhesive layer between the substrates by providing the uncured curable organopolysiloxane composition between the substrates to be laminated, and performing a curing reaction with respect to the curable organopolysiloxane composition.

Furthermore, at least one of the substrates that form the laminate body is a translucent substrate, and thus a laminate body may be formed by irradiating a high-energy beam through the transparent member substrate when the curable organopolysiloxane composition of the present invention includes the photoradical polymerization initiator (C1) and is photocurable by irradiation with a high-energy beam. Note that when a plurality of translucent substrates are present in the laminate body, a laminate precursor with an internal uncured layer made from a plurality of curable organopolysiloxane compositions is prepared to produce a “translucent substrate/curable organopolysiloxane composition/translucent substrate/curable organopolysiloxane composition . . . ” structure, and thus a plurality of organopolysiloxane adhesive layers may be formed inside the laminate body by irradiating the laminate body once with a high-energy beam by irradiating the interior of the laminate body with a high-energy beam through the translucent substrate.

Specifically, the laminate body of the present invention can be obtained by a method for manufacturing a laminate body including:
step (L3-I): a step of applying the curable organopolysiloxane composition of the present invention that is photocurable by irradiation with a high-energy beam on a substrate;
step (L3-II): a step of laminating another substrate on the curable organopolysiloxane composition applied in step (L3-I); and
step (L3-III): a step of curing or semi-curing an uncured curable organopolysiloxane composition between the substrates by irradiating a laminate precursor formed in step (L3-II) with a high-energy beam through the translucent substrate.
   Because the present method can irradiate a high-energy beam through the translucent substrate, the method is particularly suitable for a step that forms an organopolysiloxane adhesive layer between substrates with low heat resistance, and may have excellent industrial production efficiency in that the method can form a plurality of laminate bodies with low energy by irradiating with a high-energy beam at low temperatures after bonding the substrates in advance to form a laminate precursor.

The curing methods in these methods for manufacturing a laminate body may be suitably selected from a heat curing reaction and a photocuring reaction, depending on the curing reactivity of the curable organopolysiloxane, objective of use, heat resistance of the laminate body, process requirements, and the like, and the two curing reactions can be performed simultaneously or in a staged manner. Additionally, if the organopolysiloxane adhesive layer in the laminate body is in a semi-cured product state, the organopolysiloxane adhesive layer in the laminate body can be changed to a fully cured product state by completing the curing reaction by performing the same or a different curing reaction. In other words, if the organopolysiloxane adhesive layer is in a semi-cured state in the laminate body, the method for manufacturing a laminate body of the present invention may also include a step of curing the organopolysiloxane adhesive layer in a semi-cured state by at least one curing reaction selected from, optionally (i) a heat curing reaction, and (ii) a photocuring reaction by irradiation with a high-energy beam.

### [Member for Display Panel or Display]

The organopolysiloxane adhesive layer formed by curing or semi-curing the curable organopolysiloxane composition of the present invention can be used to construct and use a laminated touchscreen or flat panel display as described above. For example, a cured product obtained by curing the curable organopolysiloxane composition of the present invention can be used to manufacture a display device such as a touch panel, or the like, as the optically transparent silicone-based adhesive film or adhesive layer disclosed in Japanese PCT Patent Application Publication No. 2014-522436, Japanese PCT Patent Application Publication No. 2013-512326, and the like, as described above. Specifically, the organopolysiloxane adhesive layer of the present invention can be used as the adhesive layer or adhesive film disclosed in Japanese PCT Patent Application Publication No. 2013-512326 without any particular limitation.

As an example, the touch panel of the present invention may be a touch panel including a substrate such as a conductive plastic film having a conductive layer formed on one surface, with a cured layer obtained by curing the curable organopolysiloxane composition of the present invention, which is attached to a surface on the side that the conductive layer is formed, or on the opposite side thereof. The substrate is preferably a sheet-like or film-like substrate, with an example thereof being a resin film or a glass plate. In addition, the conductive plastic film may be a resin film or a glass plate, in particular, a polyethylene terephthalate film, having an ITO layer formed on one surface thereof. These are disclosed in the aforementioned Japanese PCT Patent Application Publication No. 2013-512326 and the like.

In addition, the organopolysiloxane adhesive layer of the present invention may be used as an adhesive film for a polarizing plate used in manufacturing a display device such as a touch panel, or the like, and may be used as an adhesive layer for adhering the touch panel and display module together as disclosed in Japanese Unexamined Patent Application Publication 2013-065009.

### INDUSTRIAL APPLICABILITY

Applications of the curing reactive organopolysiloxane composition and a cured product obtained by curing the same according to the present invention are in no way limited to the disclosure above, and an organopolysiloxane adhesive layer provided with a cured product obtained by curing the composition is capable of being used in various display devices for displaying characters, symbols, and images such as television receivers, computer monitors, monitors for personal digital assistants, monitoring monitors, video cameras, digital cameras, mobile phones, personal digital assistants, displays for instrument panels of automobiles or the like, displays for instrument panels of various types of equipment, devices, and instruments, automatic ticket machines, automated teller machines, on-board display devices, and on-board transmission screens, and the like. The surface shape of such a display device may be a curved shape or a bowed shape rather than a flat surface, with examples thereof including curved displays or curved transmission screens used in automobiles (including electric vehicles), aircraft, or the like, in addition to various flat panel displays (FPDs). Further, these display devices can display icons for executing functions or programs on a screen or display, notification indicators of e-mail, programs, or the like, and operation buttons for various devices such as car navigation devices, audio devices, and air conditioning devices, with touch panel functions enabling input operations capable of being added by touching these icons, notification indicators, or operation buttons with a finger. Application thereof is possible as a device for CRT displays, liquid crystal displays, plasma displays, organic EL displays, inorganic EL displays, LED displays, surface electrolytic displays (SEDs), field emitting displays (FEDs), and other display devices, or touch panels using the display devices. Moreover, the cured product obtained by curing the composition has excellent adhesion and viscoelastic properties, enabling the use thereof as a film-like or sheet-like member which is a member for transducers such as a membrane for speakers (including a sensor, speaker, actuator, and the like), in addition to also being capable of being used as a sealing layer or adhesive layer used in a secondary battery, fuel cell, or solar cell module.

The organopolysiloxane adhesive layer of the present invention has superior transparency and adhesion to substrates of various display devices, and the like, and thus can be suitably used in a vehicle display device with good visibility and operability of the display content over an extended period of time, and in particular, a vehicle display device having a curved screen or curved display and optionally equipped with a touch panel function. For example, vehicle display devices equipped with curved display surfaces are disclosed in Japanese Unexamined Patent Application Publication No. 2017-047767, Japanese Unexamined Patent Application Publication No. 2014-182335, Japanese Unexamined Patent Application Publication No. 2014-063064, Japanese Unexamined Patent Application Publication No. 2013-233852, and the like; however, the adhesive layer of the present invention can be suitably applied or replaced as part or all of an adhesive layer or an adhesive layer for which transparency is required in these documents. Additionally, it goes without saying that the curable organopolysiloxane composition of the present invention and cured products thereof according to the present invention can be used to replace the currently used adhesive layers or slightly adhesive layers that require transparency in other known curved display devices as well, and it is preferable to adjust the design of the display devices and the thickness of the members by known methods in order to further utilize the advantages of the organopolysiloxane adhesive layer according to the present invention.

Note that transparent film-like substrates provided with the organopolysiloxane adhesive layer of the present invention may be used to protect these display surfaces from scratches, stains, fingerprints, static electricity, reflections, and peeling.

### EXAMPLES

Hereinafter, the present invention is described in detail with reference to the examples and comparative examples, but the present invention is not limited to the following examples.

### Examples 1 to 10, Comparative Examples 1 to 4

Examples and comparative examples according to the present invention are described below. Note that “cured” in each of the examples, comparative examples, and reference examples indicates that each composition has fully cured under the respective curing conditions.

### (Preparation of a Curable Silicone Composition)

Pressure-sensitive adhesive compositions containing the curing-reactive organopolysiloxane compositions indicated in each of the examples and comparative examples were prepared using the components shown in Table 1. Note that all percentages in the same table refer to mass %. Furthermore, the viscosity and plasticity of each component are values measured at 25° C.
(A1) copolymer of dimethylsiloxane blocked by a trimethylsiloxy group on both ends and (5-hexenyl)methylsiloxane with a viscosity of 45 Pas (vinyl group content: 0.83 mass %)
(A2) dimethylsiloxane/methylvinylsiloxane copolymer raw rubber with plasticity of 120 and both ends blocked by trimethylsiloxy groups (vinyl group content: 0.84 mass %)
(A3): phenylmethylsiloxane polymer with a viscosity of 40 Pa·s and both ends blocked with dimethylvinylsiloxy groups (vinyl group content: 1.50 mass %)
(B1-1) isobornyl acrylate (produced by Tokyo Chemical Industry Co., Ltd.)
(B1-2) dodecyl acrylate (produced by Tokyo Chemical Industry Co., Ltd.)
(B1-3) trimethylolpropane triacrylate (produced by Tokyo Chemical Industry Co., Ltd.)
(B2-1) a dimethylsiloxane polymer with both ends blocked with dimethyl(acryloyloxyoctyl)siloxy groups (C₃H₃O₂ content: 8.43 mass %)
(C1-1) 2,4,6-trimethylbenzoyldiphenylphosphine oxide (product name: Omnirad TPO-L, produced by IGM Resins Co., Ltd.)
(C1-2) 2-hydroxy-2-methylpropiophenone (produced by Tokyo Chemical Industry Co., Ltd.)
(C2-1) a mixture of dibenzoyl peroxide, benzoyl-metha-methylbenzoyl peroxide, and metha-tolyl peroxide diluted with xylene (NYPER-BMT-K40 produced by NOF Corporation)
(D) xylene

### (Siloxane Mass % in Composition)

When the total mass % of component A is a, and the combined mass % of component B2 is b with respect to the total mass of the solid content (components forming the cured product excluding the organic solvent (D)) of each composition, the siloxane mass % of the composition is defined as a +b2. Note that the composition according to the present example does not include an organopolysiloxane resin component.

### (Viscosity of Curable Composition)

The viscosity (Pa·s) of the composition and each component at 25° C. was measured using a rotary viscometer (E type viscometer VISCONIC EMD produced by TOKIMEC CORPORATION).

### (Adhesiveness Measurement of UV Curable Adhesive)

Each composition was coated on a PET film (Lumirror (registered trademark) S10 produced by Toray Industries, thickness 50 μm) to a thickness after curing of 55 μm. After covering the compositions with a release film (FSC-6, thickness 50 μm produced by NIPPA Co., Ltd.), curing was performed by irradiating with ultraviolet rays at a wavelength of 365 nm from the PET film side using a UV-LED ultraviolet irradiation device (manufactured by JATEC) to bring the dose of ultraviolet irradiation (illuminance) to 4000 mJ/cm² as an integrated amount of light. After standing for 1 hour, the sample was cut to a width of 25 mm, and the adhesive layer surface was bonded to an SUS304BA plate (manufactured by PALTEK) and a PMMA board (manufactured by PALTEK, Acrylite L001, 50×120×2 mm) using a roller to form a test piece. Table 1 shows the adhesive strength (gf/25 mm) of the test piece, which was measured using a 180° peel test method in accordance with JIS Z 0237 at a tensile rate of 300 mm/min.

### (Adhesiveness Measurement of Thermosetting Adhesive)

Each composition was applied to a PET film (Lumirror (trade name) S10 produced by Toray Industries, thickness 50 μm) such that the thickness after curing was 55 μm, after which curing was performed for five minutes at 130° C. After standing for 1 hour, the sample was cut to a width of 25 mm, and the adhesive layer surface was bonded to an SUS304BA plate (manufactured by PALTEK) and a PMMA board (manufactured by PALTEK, Acrylite L001, 50×120×2 mm) using a roller to form a test piece. Table 1 shows the adhesive strength (gf/25 mm) of the test piece, which was measured using a 180° peel test method in accordance with JIS Z 0237 at a tensile rate of 300 mm/min.

### (Appearance and Measurements of Cured Product)

Two alkali-free glass plates (manufactured by Corning) were laminated with the same composition so that the thickness after curing of each composition was 200 μm. If uncured, curing was performed after bonding to produce test pieces. The haze values of the test pieces were measured using a spectrophotometer CM-5 (manufactured by Konica Minolta). Haze values of less than 1 were graded as “∘”, and haze values of 1 or more were graded as ‘x’.

TABLE 1

| | Example | Example | Example | Example | Example | Comparative | Comparative |
|---|---|---|---|---|---|---|---|
| Component | 1 | 2 | 3 | 4 | 5 | Example 1 | Example 2 |
| A1 | 88.2 | 88.2 | 88.6 | | | | 44.1 |
| A2 | | | | | 62.5 | | |
| A3 | | | | 83.3 | | 44.1 | |
| B1-1 | 9.8 | | 9.9 | | | | 53.9 |
| B1-2 | | | | | 7.0 | | |
| B1-3 | | | | 14.7 | | 53.9 | |
| B2-1 | | 9.8 | | | | | |
| C1-1 | | | 1.5 | | | | |
| C1-2 | 2.0 | 2.0 | | 2.0 | | 2.0 | 2.0 |
| C2-1 | | | | | 0.5 | | |
| D | | | | | 30.0 | | |
| Total | 100 | 100 | 100 | 100 | 130 | 100 | 100 |
| Siloxane | 88 | 98 | 89 | 83 | 89 | 44 | 44 |
| mass % | | | | | | | |
| Viscosity | 22.9 | 29.7 | 28.1 | 10.6 | 10.7 | 1.1 | 2.1 |
| Adhesiveness | 5.8 | 9 | 10 | 5.6 | 30 | Less | 4.9 |
| (SUS plate) | | | | | | than 1 | |
| Adhesiveness | 7.4 | 7.4 | 10.8 | 7 | 2.4 | Less | 5.3 |
| (PMMA plate) | | | | | | than 1 | |
| Appearance | ∘ | ∘ | ∘ | ∘ | ∘ | ∘ | x |
| After Curing | | | | | | | |

As shown in Tables 1, the composition of the present invention in examples 1 to 4 has a viscosity that allows the composition to be coated without using an organic solvent, and thus easily curable with ultraviolet rays. Furthermore, by using an organic solvent, the composition of the present invention in example 5 can have a viscosity that allows the composition to be coated and heat cured, similar to conventional methods. A cured product formed by curing the composition had a transparent appearance with no turbidity, and a practical slight adhesiveness.

On the other hand, a composition with a silicone mass % of less than 50%, like comparative example 1, lacks practicality as an adhesive layer because only a hard and brittle cured product could be obtained, or, like comparative example 2, had components that were incompatible and cloudy, making it impossible to create a transparent, slightly adhesive layer.

1. A curable organopolysiloxane composition, comprising:
(A) 50 to 99 parts by mass of a chain organopolysiloxane with two or more alkenyl groups in each molecule;
(B) 0.1 to 49.9 parts by mass of one or more type of radical reactive component selected from component (B1) and component (B2) below;
(B1) monofunctional or polyfunctional vinyl monomer;
(B2) organopolysiloxane compound having an organic group with at least one of an acryl group or methacryl group in each molecule; and
(C) 0.1 to 10 parts by mass of a radical polymerization initiator; wherein
the sum of component (A) and component (B2) is 50 mass % or more with respect to the total solid mass of the composition.

2. The curable organopolysiloxane composition according to claim 1, wherein the sum of component (A) and component (B2) is in a range of 60 to 99.5 mass % with respect to the total solid mass of the composition, and the mass ratio of an organopolysiloxane resin component to the sum of the mass of components (A) and (B2) is in a range of 0 to 0.1.

3. The curable organopolysiloxane composition according to claim 1, wherein at least a portion of component (B) is (B1-1) a vinyl monomer selected from (meth)acrylate compounds having 8 to 30 carbon atoms.

4. The curable organopolysiloxane composition according to claim 1, wherein at least a portion of component (B) is (B2-1) a chain organopolysiloxane having at least one silicon-bonded functional group R^{A} expressed by
General Formula (1): 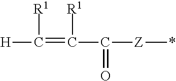
where R¹ mutually independently represents a hydrogen atom, a methyl group, or a phenyl group, and Z represents a divalent organic group which may contain a hetero atom and is bonded to a silicon atom configuring a main chain of a polysiloxane represented by *
at the terminal or side chain of the molecular chain.

5. The curable organopolysiloxane composition according to claim 1, wherein at least a portion of component (B) is (B1-1-1) a vinyl monomer selected from dodecyl acrylate, isobornyl acrylate, and 2-ethylhexyl acrylate.

6. The curable organopolysiloxane composition according to claim 1, wherein the adhesiveness of a 55 μm thick cured product layer obtained by curing the composition, as measured at a tensile rate of 300 m/min using a 180° peeling test method in accordance with JIS Z 0237 for a 2 mm thick polymethyl methacrylate sheet, is in the range of 5 to 50 gf/25 mm.

7. The curable organopolysiloxane composition according to claim 1, wherein the composition is a solvent-free or low-solvent type.

8. The curable organopolysiloxane composition according to claim 1, further comprising (D) an organic solvent in a range of 0 to 100 parts by mass.

9. The curable organopolysiloxane composition according to claim 1, wherein a viscosity at 25° C. of the entire composition is in the range of 500 to 100,000 mPa·s.

10. The curable organopolysiloxane composition according to claim 1, wherein at least a portion of component (C) is (C1) a photoradical polymerization initiator and is photo-curable by irradiation with a high energy beam.

11. The curable organopolysiloxane composition according to claim 1, wherein at least a portion of component (C) is (C2) a thermal radical polymerization initiator and is heat-curable.

12. An organopolysiloxane adhesive layer obtained by curing or semi-curing the curable organopolysiloxane composition according to claim 1.

13. An elastic adhesive member obtained by curing the curable organopolysiloxane composition according to claim 1.

14. A laminate body, comprising:
an organopolysiloxane adhesive layer obtained by curing or semi-curing the curable organopolysiloxane composition according to claim 1 on a film-like substrate.

15. The laminate body according to claim 14, wherein a release layer for the organopolysiloxane adhesive layer is provided on one, or two or more, film-like substrates.

16. A laminate body, comprising:
an organopolysiloxane adhesive layer obtained by curing or semi-curing the curable organopolysiloxane composition according to claim 1 between at least two substrates.

17. A method for manufacturing the laminate body according to claim 14, the method comprising:
step (L1-I): a step that applies the curable organopolysiloxane composition onto a film-like substrate which may optionally have a release layer; and
step (L1A-II): a step of curing or semi-curing the curable organopolysiloxane composition applied in step (L1A-I) by at least one type of curing reaction selected from, (i) a heat curing reaction and, (ii) a photocuring reaction by irradiation with a high-energy beam.

18. A method for manufacturing the laminate body according to claim 16, the method comprising:
step (L2A-I): a step of applying the curable organopolysiloxane composition on a first substrate;
step (L2A-II): a step of curing or semi-curing the curable organopolysiloxane composition applied in step (L2A-I) by at least one type of curing reaction selected from, (i) a heat curing reaction and, (ii) a photocuring reaction by irradiation with a high-energy beam; and optionally,
step (L2A-III): a step of laminating another substrate on an organopolysiloxane adhesive layer formed in step (L2A-2).

19. A method for manufacturing the laminate body according to claim 16, the method comprising:
step (L2B-I): a step of applying the curable organopolysiloxane composition on a first substrate;
step (L2B-II): a step of laminating another substrate on the curable organopolysiloxane composition applied in step (L2B-I); and
step (L2B-III): a step of curing or semi-curing the uncured curable organopolysiloxane composition between substrates for the laminate body precursor formed in step (L2B-II) by at least one type of curing reaction selected from, (i) a heat curing reaction and, (ii) a photocuring reaction by irradiation with a high-energy beam.

20. A method for manufacturing the laminate body according to claim 16, where at least one of the substrates forming the laminate body is a translucent substrate, the method comprising:
step (L3-I): a step of applying the curable organopolysiloxane composition, wherein it is curable by irradiation with a high-energy beam, on a substrate;
step (L3-II): a step of laminating another substrate on the curable organopolysiloxane composition applied in step (L3-I); and
step (L3-III): a step of curing or semi-curing an uncured curable organopolysiloxane composition between the substrates by irradiating a laminate precursor formed in step (L3-II) with a high-energy beam through the translucent substrate.

21. (canceled)

22. (canceled)
